(19) United States
(12) Patent Application Publication
(10) Pub. No.: US 2005/0049358 A1
(43) Pub. Date: Mar. 3, 2005

(54) Water dispersible polyisocyanate composition bearing urea and/or biuret and its uses

(75) Inventors: Shenghong A. Dai, Taichung City (TW); Chinghung Chen, Taiping City (TW); Will Yang, Taichung City (TW); Tsai-Lung Chen, Taichung City (TW)

Correspondence Address: Ladas & Parry, 26 West 61st Street, New York, NY, 10023, US

(73) Assignee: GREAT EASTERN RESINS INDUSTRIAL CO., LTD.

(21) Appl. No.: 10/724,923

(22) Filed: Dec. 1, 2003

(30) Foreign Application Priority Data
Aug. 27, 2003 (TW) 092123595

(51) Int. Cl. C08K 3/00

(52) U.S. Cl. 524/589

(57) ABSTRACT

The present invention relates to a water dispersible polyisocyanate composition bearing urea comprising (a) an aliphatic polyisocyanate or a mixture of aliphatic polyisocyanates or a mixture of aliphatic polyisocyanates with other polyisocyanates; and (b) a reaction product of component (a) with component (c) a polyether amine or a mixture of a polyether amine and a polyether alcohol. The present invention also relates to a water dispersible polyisocyanate composition bearing urea and urea derivatives which is obtained by heating the above composition bearing urea for conducting a subsequent reaction, to increase the numbers of isocyanate functional groups contained in said composition, wherein the urea derivatives include biuret, triuret and tetrauret, and most of them are biuret. The present invention further relates to a water dispersible polyisocyanate composition bearing biuret which is obtained by heating the above composition bearing urea for conducting a subsequent reaction, to increase the numbers of isocyanate functional groups contained in said composition. The present invention another relates to an aqueous resin adhesive which contains the water dispersible polyisocyanate composition of the present invention and an aqueous resin containing active hydrogen reactive groups.

### FIELD OF THE INVENTION

The present invention relates to a water dispersible polyisocyanate composition, particularly a water dispersible polyisocyanate composition bearing urea or biuret, and to an aqueous resin adhesive comprising such water dispersible polyisocyanate composition as a crosslinking agent and an aqueous resin containing active hydrogen reactive groups.

### BACKGROUND OF THE INVENTION

Water dispersible polyisocyanates are commonly applied in the adhesives based on the aqueous resins as crosslinking agents. Particularly, the isocyanates are highly reactive to the compounds having active hydrogen groups so as to form, for example, urethane, urea, amide, allophanate, and biuret products. Thus, the polyisocyanates are advantageous to the molecular growth and crosslinking of the resins so as to extensively improve their adhesion, heat resistance, and mechanical performance when being used as adhesives. The characteristic of high reactivity of the polyisocyanates allows them to be an excellent crosslinking agent for the aqueous resins.

The preparations and applications of the water dispersible polyisocyanates are known and have been disclosed. For example, U.S. Pat. No. 4,663,377 discloses the utilization of one or more aliphatic polyisocyanates having an average NCO functionality of about 2.0 to 3.5, to react with hydrophilic materials of polyether monols, such as poly ethoxylated ether monol exemplified in the examples provided thereof. The obtained water dispersible polyisocyanate preparation has an NCO % of 18.4% and a viscosity of 2500 cps/23° C. The water dispersible polyisocyanate preparation in an amount of 2 wt % to 10 wt % is added to an aqueous adhesive so as to enhance the adhesive performance.

U.S. Pat. No. 5,200,489 relates to the use of a polyether monol to modify polyisocyanates based on 1,6-hexamethylene diisocyanate (HDI) or a mixture of HDI with up to 70% by weight, based on the weight of the diisocyanate, of another diisocyanate, to obtain a water dispersible polyisocyanate composition having an average NCO functionality of 2 to 6, and further provides a method for testing the water dispersibility of the polyisocyanate composition. The test results show that the polyether monol in an amount of about 10 wt % and having a molecular weight of 200 to 1000 g/mole is more favorable to improve the water dispersibility of the polyisocyanate composition.

U.S. Pat. No. 5,252,696 teaches a water dispersible polyisocyanate mixture obtained by reacting an aliphatic polyisocyanate having an NCO functionality of about 2.1 to 4.4, such as HDI trimer, with a polyether monol containing 5 to 9.9 ethylene oxide (EO) units, at an NCO/OH equivalent ratio of 4:1 to 120:1. One synthesis example relates to the addition of poly ethoxylated ether monol to HDI trimer for conducing reaction so as to obtain a product having an NCO % of 17.3% and a viscosity of 3050 cps/23° C. The obtained water dispersible polyisocyanate mixture is then added to an aqueous acrylic dispersant bearing a hydroxyl group, so as to provide good surface gloss and solvent resistance.

U.S. Pat. No. 6,221,995 discloses a modified polyisocyanate which has a high emulsifying/dispersing ability in an aqueous resin composition and can be advantageously used as a curing or crosslinking agent. The modified polyisocyanate is prepared by reacting an HDI-based isocyanurate group-containing polyisocyanate and a nonionic emulsifying agent, poly ethoxylated ether monol. U.S. Pat. No. 6,221,995 mentions that the hydrophilic structure of a polyether monol is expressed by a hydrophile-lipophile balance (HLB), and indicates that a water dispersible polyisocyanate synthesized from a polyether monol having a HLB of 17 or less (about 5 to 17) provides better performance when used in aqueous coatings, inks, and adhesives.

In view of the known technologies, the water dispersible polyisocyanates are normally prepared by reacting an aliphatic polyisocyanate based on HDI trimer with a nonionic polyether monol having a low molecular weight. Nonetheless, the reaction rate of a polyether alcohol with a polyisocyanate is slow and normally need to be accelerated by adding catalysts. Moreover, the water dispersible polyisocyanates of the prior art cannot immediately enhance the initial adhesion between rubbers and rubbers when being used in the adhesion of rubber substrates.

The inventors of the present invention have found that the reaction rate of polyether amines or mixtures of polyether amines and polyether alcohols with polyisocyanates is faster than that of polyether alcohols with polyisocyanates, which is advantage ous to prepare water dispersible polyisocyanate compositions, especially water dispersible polyisocyanate compositions bearing urea or biuret. In addition, the water dispersible polyisocyanate composition of the present invention is more favorable for use in an aqueous resin as a crosslinking agent, compared with those prepared by the prior art technologies. Particularly, the aqueous resin adhesives crosslinked with the water dispersible polyisocyanate composition of the present invention have increased mechanical properties, such as adhesive ability, including the initial and aging adhesion, and heat resistance.

### SUMMARY OF THE INVENTION

The present invention relates to a water dispersible polyisocyanate composition bearing urea comprising
(a) an aliphatic polyisocyanate or a mixture of aliphatic polyisocyanates or a mixture of aliphatic polyisocyanates with other polyisocyanates; and
(b) a reation product of component (a) with component (c) a polyether amine or a mixture of a polyether amine and a polyether alcohol.

The present invention also relates to a water dispersible polyisocyanate composition bearing urea and urea derivatives which is obtained by heating the above composition bearing urea for conducting a subsequent reaction. The subsequent reaction at an elevated temperature can increase the numbers of isocyanate functional groups contained in said composition. The urea derivatives include biuret, triuret and tetrauret, and most of them are biuret.

The present invention further relates to a water dispersible polyisocyanate composition bearing biuret which is obtained by heating the above composition bearing urea for conducting a subsequent reaction, to increase the numbers of isocyanate functional groups contained in said composition.

The present invention another relates to an aqueous resin adhesive which contains the water dispersible polyisocyanate composition of the present invention and an aqueous resin containing active hydrogen reactive groups.

### DETAILED DESCRIPTION OF THE INVENTION

Polyisocyanate

The polyisocyanate used in the present invention is an aliphatic polyisocyanate or a mixture of aliphatic polyisocyanates or a mixture of aliphatic polyisocyanates with other polyisocyanates having an average NCO functionality of about 2 to about 6, preferably about 2.5 to about 4, and an NCO content of about 5% to about 30%, preferably about 10% to about 25%.

In the present invention, suitable aliphatic polyisocyanates include, but are not limited to, isocyanates with following derivatives, such as isocyanurate, biuret, uretdione, urethane, allophanate, carbodiimide, oxadiazinetrione derivatives and mixtures thereof. The aliphatic polyisocyanates and their preparation processes are known and described in the prior art such as U.S. Pat. Nos. 4,518,522 and 4,663,377, the disclosures of which are incorporated by reference. Preferred aliphatic polyisocyanate is a cyclic polyisocyanate, such as isocyanurate derivative, biuret derivative or a mixture thereof, more preferably, HDI trimer, isophorone diisocyanate (IPDI) trimer or HDI/IPDI trimer, or a mixture thereof.

Other polyisocyanates for use in the present invention may be any known and conventionally used in the art, such as aromatic polyisocyanates. Suitable aromatic polyisocyanates include, but are not limited to, 4,4-diphenylmethane diisocyanate (MDI), polymeric MDI, toluene diisocyanate and xylene diisocyanate, and a mixture thereof. The aromatic polyisocyanates and their preparation processes are also known and described in the prior art such as U.S. Pat. No. 4,939,191, the disclosures of which are incorporated by reference.

Polyether Amine

The polyether amines used in the present invention can be prepared through any known methods. For example, the alkoxylation of suitable initiators with ethylene oxide (EO) or a mixture of EO and propylene oxide (PO) to prepare polyether alcohols, and then conversion of the terminal hydroxyl groups of the polyether alcohols to amino groups. Suitable initiators include, but are not limited to, methanol, ethanol, n-butanol, n-propanol, isopropanol, cyclohexanol, phenol, water, ethylene glycol, diethylene glycol (DEG), propylene glycol, glycerin, 2-butone oxime, aniline, trimethylol propane, and 3-methyl-3-hydroxymethyloxetane.

According to the present invention, the polyether amines have the weight ratio of EO to PO in the range of greater than about 50:50, preferably between about 60:40 and about 95:5, and more preferably between about 70:30 and about 90:10. If the hydrophilic ability of the residual hydrophilic groups contained in the formed aqueous resin adhesive is too strong, the aqueous resin adhesive will have tendency to adsorb too much water in its hydrophilic groups so as to easily result in the hydrolysis of the neighboring urea, urethane, biuret, and allophanate and decrease its adhesive performance. Therefore, in the present invention, introducing a hydrophobic group, i.e., PO, in a proportion corresponding to a hydrophilic groups/hydrophobic groups ratio of greater than about 50:50, preferably between about 60:40 and about 95:5, and more preferably between about 70:30 and about 90:10, to the polyether amine for preparing a water dispersible polyisocyanate composition can provide a suitable prevention of the excessive consumption of the isocyanate groups during mixing of the polyisocyanates with the aqueous resin, and also enhance the initial adhesion by the linkage of the hydrophobic group with amine, hydroxyl, and/or carboxyl groups of the aqueous resin.

The polyether amine used in the present invention can be selected from, but are not limited to, polyether monoamine, polyether diamine, polyether triamine, and a mixture thereof, preferably polyether monoamine and polyether diamine. The molecular weights of the polyether monoamine and polyether diamine are about 500 to about 3000 g/mole, preferably about 600 to about 2500 g/mole, more preferably about 800 to about 1200 g/mole.

The examples of the polyether monoamine that can be used in the present invention include, but are not limited to, JEFFAMINE® M-1000 and JEFFAMINE® M-2070. The examples of the polyether diamine that can be used in the present invention include, but are not limited to, JEFFAMINE® ED-600, JEFFAMINE® ED-900, JEFFAMINE® ED-2001, and JEFFAMINE® ED-2003. The above JEFFAMINE® series are the products of Huntsman.

Polyether Alcohol

The polyether alcohols used in the present invention can be prepared through any known methods, such as by the alkoxylation of suitable initiators with EO or a mixture of EO and PO. The suitable initiators are those mentioned above.

As explicated in the section of polyether amine, in the present invention, the polyether alcohols have the weight ratio of EO to PO in the range of greater than about 50:50, preferably between about 60:40 and about 95:5, and more preferably between about 70:30 and about 90:10.

The polyether alcohol used in the present invention can be selected from, but are not limited to, polyether monol, polyether diol, polyether triol, and a mixture thereof, preferably polyether diol. The molecular weights of the polyether monol, polyether diol, and polyether triol are respectively about 150 to 800 g/mole, preferably about 300 to 500 g/mole; about 300 to 1600 g/mole, preferably about 500 to 1000 g/mole, more preferably about 600 to 800 g/mole; and about 450 to 2400 g/mole, preferably about 600 to 1800 g/mole, more preferably 900 to 1200 g/mole.

Water Dispersible Polyisocyanate Composition

The water dispersible polyisocyanate composition of the present invention can be prepared by any known methods. According to the present invention, the production of reaction product (b) takes place by reacting a polyisocyanate or a mixture of aliphatic polyisocyanates or a mixture of aliphatic polyisocyanates with other polyisocyanates with a polyether amine or a mixture of a polyether amine and a polyether alcohol. Generally, reaction product (b) can either be produced in a separate step by the reaction of a polyisocyanate or a mixture of aliphatic polyisocyanates or a mixture of aliphatic polyisocyanates with other polyisocyanates with a polyether amine or a mixture of a polyether amine and a polyether alcohol, and then mixed with component (a) to form a water dispersible polyisocyanate composition, or it can be produced in situ. The polyisocyanates used to produce reaction product (b) can be either the same or different from component (a) in species.

According to the present invention, it is preferred that reaction product (b) is produced in situ. In other words, the water dispersible polyisocyanate composition is prepared in one step process where a higher excess of NCO groups contained in component (a) is used to react with component (c).

In this embodiment, component (a) can react with component (c) at room temperature for about 2 to about 4 hours without the presence of a catalyst. Also, in this embodiment, the composition is prepared by reacting about 99.5% to about 92% of component (a) with about 0.5% to about 8% of component (c), preferably about 99% to about 96% of component (a) with about 1% to about 4% of component (c), on the basis of the weight of the composition. If component (c) is a mixture of polyether amines, the polyether amines can be formed by mixing polyether monoamines, polyether diamines, and polyether triamines in any suitable ratios, preferably formed by mixing polyether monoamines and polyether diamines in a ratio of 1:4 to 13:1. If component (c) is a mixture of polyether amines and polyether alcohols, the composition is prepared by reacting about 99% to about 92% of component (a) with about 0.5% to about 4% of polyether amines and about 0.5% to about 4% of polyether alcohols, on the basis of the weight of the composition. Preferably, the ratio of the polyether amines and polyether alcohols in component (c) is about 1:3 to about 2:3.

If only a polyether amine is used to react with a polyisocyanate, the obtained water dispersible polyisocyanate has a structure of the urea functional group, i.e., a polyisocyanate bearing urea. If a mixture of a polyether amine and a polyether alcohol is used to react with a polyisocyanate, the obtained water dispersible polyisocyanate has structures of the urea and urethane functional groups. Compared with the reaction of a polyether alcohol having a low molecular weight with a polyisocyanate, the use of a polyether amine can extensively reduce the reaction time, even without adding any catalyst to assist the reaction.

The above water dispersible polyisocyanate composition having the structure of the urea functional group of a part of the polyisocyanate can be heated to a temperature of about 100 to about 150° C. for conducting a subsequent reaction for about 2 to about 8 hours. It is well known that the reaction time depends upon the reaction temperature. In the present invention, the temperature is preferably raised to about 110° C. for conducting a subsequent reaction for about 5 hours. Such heating treatment promotes the reaction of the structure of the urea functional group contained in the water dispersible polyisocyanate to form structures of the urea and urea derivatives functional groups. Most, even all, portion of the reaction product obtained by the heating treatment is urea derivatives. The urea derivatives include biuret, triuret, tetrauret, and most of them are biuret.

Therefore, the present invention provides a water dispersible polyisocyanate composition bearing urea, preferably a water dispersible polyisocyanate composition bearing urea and urea derivatives, more preferably a water dispersible polyisocyanate composition bearing urea and biuret, and a water dispersible polyisocyanate composition bearing biuret, which are characterized by being prepared through hearting the above water dispersible polyisocyanate composition bearing urea for conducting a subsequent reaction so as to increase the numbers of the isocyanate functional groups contained in the composition.

Regarding the above obtained water dispersible polyisocyanate composition having structures of the urea and urethane functional groups can be similarly heated to a temperature of about 100° C. to about 150° C. for conducting a subsequent reaction for about 2 to about 8 hours, preferably to a temperature of about 110° C. for conducting a subsequent reaction for about 5 hours. The heating can promote the structures of the urea and urethane functional groups contained in the water dispersible polyisocyanate composition to form the structures of urea and urea derivatives and allophanate functional groups. Most, even all, portion of the reaction product obtained by heating treatment is urea derivatives and allophanate. The urea derivatives comprise biuret, triuret, and tetrauret, and most of them are biuret. Therefore, in one embodiment, the present invention provides a water dispersible polyisocyanate composition bearing urea and urea derivatives and allophanate, preferably a water dispersible polyisocyanate composition bearing urea derivatives and allophanate, more preferably a water dispersible polyisocyanate composition bearing urea and biuret and allophanate, and a water dispersible polyisocyanate composition bearing biuret and allophanate. The viscosity of the resulted water dispersible polyisocyanate composition has great relationship with the amount of the polyether amine and its species and molecular weight. Concretely speaking, since urea functional groups easily form hydrogen-bonding with each other, a low molecular weight water dispersible polyisocyanate composition having the structure of the urea functional groups, which is prepared from a low molecular weight polyether amine, has the urea functional groups in a higher concentration, i.e., more pseudo-bondings between the molecules, and exhibits a higher viscosity. If the above composition is treated by heating and the urea functional groups convert to the biuret functional groups, the hydrogen-bonding phenomena is reduced, so that the viscosity of the water dispersible polyisocyanate composition is decreased by up to 25% to 300%. When the polyether diamine is used, the viscosity can be decreased by up to 3000%. The decrease range depends upon the species of the polyether amine and its molecular weight and added amount.

In one embodiment, to further control the viscosity of the water dispersible polyisocyanate composition, an inert organic solvent of low boiling point may be added to the polyisocyanate composition before it is used. The organic solvent can be, but are not limited to, ethyl acetate, acetone, dimethyl ethyleneglycol, methylethylketone, or a mixture thereof, preferably ethyl acetate, and its added amount is adjusted in order to control the viscosity of the final water dispersible polyisocyanate composition as desired.

Aqueous Resin Adhesive

According to the present invention, combining the water dispersible polyisocyanate composition of the present invention with the aqueous resins may be carried out by using any known stirring means, e.g., mechanical stirring.

Examples of suitable aqueous resins for the production of aqueous resin adhesives of the present invention include those containing active hydrogen reactive groups, such as a hydroxyl group, an amino group, a carboxyl group and the like, particularly a hydroxyl and amino group. According to the present invention, preferred aqueous resins are aqueous polyurethanes (PUs), aqueous polyvinyl acetates (PVACs), aqueous polyvinyl alcohols (PVOHs), aqueous hydroxy polyacrylates, and mixtures thereof, preferably aqueous PUs. As for the mixing of the water dispersible polyisocyanate composition and the aqueous resin, the amount of the water dispersible polyisocyanate composition is about 1 to about 5 wt %, preferably about 2 to about 4 wt %, based on the weight of the aqueous resin.

The aqueous resin adhesive according to the present invention is suitable for bonding selected materials of the same or different types, for example, wood, paper, plastics, textiles, leather, and inorganic materials, especially PUs, polyvinyl chlorides (PVCs), and rubbers.

The addition of the water dispersible polyisocyanate composition bearing urea or biuret of the present invention to the aqueous resin causes, in particular, improvements in the adhesive ability and heat resistance. Moreover, the present invention provides significant improved efficacy in the initial adhesion strength between the rubber substrates, compared with the water dispersible polyisocyanate compositions formed from polyether alcohols and polyisocyanates.

The following examples serve to explain the invention in more detail. All percentages are percentages by weight unless otherwise indicated.

### EXAMPLES

### Example 1

The preparation of water dispersible polyisocyanate compositions by using a polyether monoamine or diamine.

HDI trimer, prepared by trimerizing HDI and having a viscosity of about 3000 cps/25° C. and a NCO % of about 21 to 22% (commercially available from Bayer Corp., Rhodia Chimie or BASF Aktiengesellschaft), was added to a capped separating reactor and mechanically stirred with a Teflon bar. As listed in Table 1, a polyether monoamine or diamine commercially available from Huntsman was slowly added to the reactor for about 30 minutes. A portion (about 300 g) was heated to 110° C. and reacted under the temperature for about 5 hours, and then was cooled to room temperature.

TABLE 1

| Modifying material | EO/PO ratio | MW (g/mole) |
|---|---|---|
| Polyether monoamine | | |
| Monoamine-1 | 32/10 | 2000 |
| Monoamine-2 | 19/3 | 1000 |
| Polyether diamine | | |
| Diamine-1 | 39.5/5 | 2000 |
| Diamine-2 | 5.5/2.5 | 900 |

The amounts of HDI trimer and polyether amines for the production of water dispersible polyisocyanate compositions, and the NCO % and viscosities of the obtained water dispersible polyisocyanate compositions are shown in Table 2.

TABLE 2

| | | | | Added | | | |
|---|---|---|---|---|---|---|---|
| Sample | Starting | Ratios | Ratios in | amounts | Reaction | | Viscosity |
| number | materials | in wt % | equivalents | (g) | temp. | NCO % | (cps/° C.) |
| 1A | HDI trimer | 93.13 | 138.83 | 279.4 | RT | 19.55 | 2600/ 31.1 |
| | Monoamine-1 | 6.87 | 1 | 20.6 | | | |
| 1B | HDI trimer | 93.13 | 138.83 | 279.4 | 110° C. | 19.36 | 3100/31.2 |
| | Monoamine-1 | 6.87 | 1 | 20.6 | | | |
| 2A | HDI trimer | 93.13 | 69.42 | 279.4 | RT | 18.38 | 53360/27.5 |
| | Monoamine-2 | 6.87 | 1 | 20.6 | | | |
| 2B | HDI trimer | 93.13 | 69.42 | 279.4 | 110° C. | 17.57 | 4950/27.5 |
| | Monoamine-2 | 6.87 | 1 | 20.6 | | | |
| 3A | HDI trimer | 94 | 80.56 | 282 | RT | 19.11 | 17110/27.5 |
| | Monoamine-2 | 6 | 1 | 18 | | | |
| 3B | HDI trimer | 94 | 80.56 | 282 | 110° C. | 18.9 | 4170/27.5 |
| | Monoamine-2 | 6 | 1 | 18 | | | |
| 4A | HDI trimer | 95 | 97.33 | 285 | RT | 19.15 | 7000/27.5 |
| | Monoamine-2 | 5 | 1 | 15 | | | |
| 4B | HDI trimer | 95 | 97.33 | 285 | 110° C. | 18.94 | 2338/27.5 |
| | Monoamine-2 | 5 | 1 | 15 | | | |
| 5A | HDI trimer | 96 | 123.33 | 288 | RT | 21 | 28440/27.5 |
| | Monoamine-2 | 4 | 1 | 12 | | | |
| 5B | HDI trimer | 96 | 123.33 | 288 | 110° C. | 18.98 | 4464/27.5 |
| | Monoamine-2 | 4 | 1 | 12 | | | |
| 6A | HDI trimer | 97 | 165.56 | 291 | RT | 19.76 | 26850/27.5 |
| | Monoamine-2 | 3 | 1 | 9 | | | |
| 6B | HDI trimer | 97 | 165.56 | 291 | 110° C. | 19.02 | 5640/24.7 |
| | Monoamine-2 | 3 | 1 | 9 | | | |
| 7A | HDI trimer | 97 | 165.56 | 291 | RT | 21.61 | 120000/27 |
| | Diamine-1 | 3 | 1 | 9 | | | |
| 7B | HDI trimer | 97 | 165.56 | 291 | 110° C. | 19.19 | 4122/27 |
| | Diamine-1 | 3 | 1 | 9 | | | |
| 8A | HDI trimer | 98 | 251.67 | 294 | RT | 21.91 | 107600/27 |
| | Diamine-1 | 2 | 1 | 6 | | | |
| 8B | HDI trimer | 98 | 251.67 | 294 | 110° C. | 21.68 | 3932/27 |
| | Diamine-1 | 2 | 1 | 6 | | | |
| 9A | HDI trimer | 98 | 113.53 | 294 | RT | 20.79 | 7400/26.5 |
| | Diamine-2 | 2 | 1 | 6 | | | |
| 9B | HDI trimer | 98 | 113.53 | 294 | 110° C. | 20.38 | 4080/26.5 |
| | Diamine-2 | 2 | 1 | 6 | | | |

RT: room temperature

### Example 2

The preparation of water dispersible polyisocyanate compositions by using a polyether monoamine and a polyether diamine

The preparation procedures were as those described in Example 1, except that a mixture of Monoamine-1 and Diamine-1 were reacted with HDI trimer. The amounts of HDI trimer, Monoamine-1, and Diamine-1 for the production of water dispersible polyisocyanate compositions, and the NCO % and viscosities of the obtained water dispersible polyisocyanate compositions are shown in Table 3.

TABLE 3

| | | | | Added | | | |
|---|---|---|---|---|---|---|---|
| Sample | Starting | Ratios | Ratios in | amount | Reaction | | Viscosity |
| number | materials | in wt % | equivalents | (g) | temp. | NCO % | (cps/° C.) |
| 10A | HDI trimer | 93.13 | 694.17 | 279.4 | RT | 19.18 | 2940/29.4 |
| | Monoamine-1 | 6.183 | 4.5 | 18.54 | | | |
| | Diamine-1 | 0.687 | 1 | 2.06 | | | |
| 10B | HDI trimer | 93.13 | 694.17 | 279.4 | 110° C. | 18.95 | 4060/29.5 |
| | Monoamine-1 | 6.183 | 4.5 | 18.54 | | | |
| | Diamine-1 | 0.687 | 1 | 2.06 | | | |
| 11A | HDI trimer | 93.13 | 347.09 | 279.4 | RT | 19.93 | 3720/29.5 |
| | Monoamine-1 | 5.496 | 2 | 16.48 | | | |
| | Diamine-1 | 1.374 | 1 | 4.12 | | | |
| 11B | HDI trimer | 93.13 | 347.09 | 279.4 | 110° C. | 18.55 | 4440/29.6 |
| | Monoamine-1 | 5.496 | 2 | 16.48 | | | |
| | Diamine-1 | 1.374 | 1 | 4.12 | | | |
| 12A | HDI trimer | 93.13 | 694.17 | 279.4 | RT | 20.34 | 22680/27.5 |
| | Monoamine-1 | 6.183 | 9 | 18.54 | | | |
| | Diamine-1 | 0.687 | 1 | 2.06 | | | |
| 12B | HDI trimer | 93.13 | 694.17 | 279.4 | 110° C. | 17.17 | 4890/27.5 |
| | Monoamine-1 | 6.183 | 9 | 18.54 | | | |
| | Diamine-1 | 0.687 | 1 | 2.06 | | | |

RT: room temperature

### Example 3

The preparation of water dispersible polyisocyanate compositions by using a polyether monoamine or polyether diamine and a polyether diol

The preparation procedures were as those described in Example 1, except that a mixture of Monoamine-2 or Diamine-1 and Diol-1 were reacted with HDI trimer. Diol-1 is commercially available from Eu Hou Polymer Chemical Industry Co., Ltd and has an EO/PO ratio of about 80/20 and a molecular weight of about 700 g/mole. The amounts of HDI trimer, Monoamine-2, Diamine-1, and Diol-1 for the production of water dispersible polyisocyanate compositions, and the NCO % and viscosities of the obtained water dispersible polyisocyanate compositions are shown in Table 4.

TABLE 4

| | | | | Added | | | |
|---|---|---|---|---|---|---|---|
| Sample | Starting | Ratios | Ratios in | amount | Reaction | | Viscosity |
| number | materials | in wt % | equivalents | (g) | temp. | NCO % | (cps/° C.) |
| 13A | HDI trimer | 96 | 493.33 | 288 | RT | 20.34 | 2780/27.5 |
| | Monoamine-2 | 1 | 1 | 3 | | | |
| | Diol-1 | 3 | 8.57 | 9 | | | |
| 13B | HDI trimer | 96 | 493.33 | 288 | 110° C. | 19.93 | 3672/27.5 |
| | Monoamine-2 | 1 | 1 | 3 | | | |
| | Diol-1 | 3 | 8.57 | 9 | | | |
| 14A | HDI trimer | 95 | 243.33 | 285 | RT | 20.13 | 2720/27.5 |
| | Monoamine-2 | 2 | 1 | 6 | | | |
| | Diol-1 | 3 | 4.28 | 9 | | | |
| 14B | HDI trimer | 95 | 243.33 | 285 | 110° C. | 19.56 | 2920/27.5 |
| | Monoamine-2 | 2 | 1 | 6 | | | |
| | Diol-1 | 3 | 4.28 | 9 | | | |
| 15A | HDI trimer | 96 | 493.33 | 288 | RT | 19.66 | 3120/28.5 |
| | Diamine-1 | 1 | 1 | 3 | | | |
| | Diol-1 | 3 | 8.57 | 9 | | | |
| 15B | HDI trimer | 96 | 493.33 | 288 | 110° C. | 19.38 | 4722/28.5 |
| | Diamine-1 | 1 | 1 | 3 | | | |
| | Diol-1 | 3 | 8.57 | 9 | | | |
| 16A | HDI trimer | 95 | 243.33 | 285 | RT | 19.88 | 5400/28.5 |
| | Diamine-1 | 2 | 1 | 6 | | | |
| | Diol-1 | 3 | 4.28 | 9 | | | |
| 16B | HDI trimer | 95 | 243.33 | 285 | 110° C. | 18.78 | 4278/28.5 |
| | Diamine-1 | 2 | 1 | 6 | | | |
| | Diol-1 | 3 | 4.28 | 9 | | | |

RT: room temperature

### Example 4

Adhesion and heat resistance after adhesion tests of the aqueous PU adhesives.

1.5 g of the water dispersible polyisocyanate compositions according to the samples prepared in the above Examples and 1.5 g of a commercial product (Sample C), an aliphatic polyisocyanate free of water, synthesized from HDI trimer and a polyether monol and having an NCO % of 18.5 to 20.5% and a viscosity of 3,000 mPa s/23° C., were respectively added to 48.5 g of aqueous PUs (trade name: GE-6608, manufactured by Great Eastern Resins Industrial Co., Ltd.) to prepare aqueous PU adhesives. Since the aqueous PUs for each test were obtained from different batch preparations, the test results were based on those of Sample C. In other words, the obtained data was for the comparison purpose of the adhesion or heat resistance, rather than an absolute value. The operational procedures for testing the adhesion and heat resistance after adhesion of the aqueous PU adhesive between rubber substrates are as follows:
1. Using a roughening machine to roughen the surfaces of rubber substrates (10 cm×2.5 cm) to be adhered.
2. The surfaces of the rubber substrates were treated with a primer (trade name: GE-001AB, manufactured by Great Eastern Resins Industrial Co., Ltd.).
3. The treated rubber substrates were dried in an oven at 60° C. for 3 minutes.
4. The dried rubber substrates were well applied with an aqueous PU adhesive containing a water dispersible polyisocyanate composition.
5. The coated rubber substrates were further dried in an oven at 60° C. for 5 minutes.
6. Two of the rubber substrates obtained from Step 5 were adhered through the coated surfaces, and then pressed under a pressure of 30 kg for 10 sec.
7. The adhered rubber substrates were statically placed for 10 minutes, and then their initial green strength was tested by using Computer Type Universal Testing Machine.
8. The adhered rubber substrates were statically placed for 1 hour, and then their adhesion was tested by using Universal Testing Machine also.
9. The adhered rubber substrates were statically placed for 24 hours, and then their aging adhesion was tested by using Universal Testing Machine also.
10. The adhered rubber substrates were statically placed for 72 hours, and then placed in an oven of 70° C. and loaded with a mass of 1.5 kg for 60 hours, to test the heat resistance of aging.
   Test (A)

The aqueous PU adhesives crosslinked with Sample 1B or C were subjected to the adhesion test according to the above procedures. The test results are shown in Table 5.

TABLE 5

| | |
|---|---|
| Sample 1B | Sample C |

| | |
|---|---|
| Test Time | Peel Strength (kg/2.5 cm) |

| | | | |
|---|---|---|---|
| 10 | minutes | 6.2 | 5.7 |
| 1 | hour | 7.3 | 6.2 |
| 24 | hours | 9.1 | 8.9 |

According to the test results, the performance of Sample 1B in improving the adhesion of the aqueous PU adhesives exceeded that of Sample C, i.e., the commercial product.

Test (B)

The aqueous PU adhesives crosslinked with Sample 6B or C were subjected to the adhesion and heat resistance tests according to the above procedures. The test results are shown in Table 6.

TABLE 6

| | Sample 6B | Sample C |
|---|---|---|
| | Peel Strength (kg/2.5 cm) | |
| Test Time | | |
| 10 minutes | 21 | 16 |
| 1 hour | 28 | 21 |
| 24 hours | 29 | 22 |
| Heat resistance | | |
| Falling time of the mass | No falling occurred | No falling occurred |
| (min) | | |
| Released distance | 0.2 | 0.3 |
| between the substances | | |
| (cm) | | |

According to the test results, the performances of Sample 6B in improving the adhesion and heat resistance after adhesion of the aqueous PU adhesives exceeded those of Sample C, i.e., the commercial product.

Test (C)

The aqueous PU adhesives crosslinked with Sample 7B, 8B, or C were subjected to the adhesion and heat resistance after adhesion tests according to the above procedures. The test results are shown in Table 7.

TABLE 7

| | Sample 7B | Sample 8B | Sample C |
|---|---|---|---|
| | Peel Strength (kg/2.5 cm) | | |
| Test Time | | | |
| 10 minutes | 18.5 | 18.5 | 18 |
| 1 hour | 24.5 | 25.5 | 23.5 |
| 24 hours | 24 | 29.5 | 26 |
| Heat resistance | | | |
| Falling time of the mass | No falling | No falling | No falling |
| (min) | occurred | occurred | occurred |
| Released distance | 1.4 | 2.2 | 7.5 |
| between the substances | | | |
| (cm) | | | |

According to the test results, the performances of Samples 7B and 8B in improving the adhesion and heat resistance after adhesion of the aqueous PU adhesives exceeded those of Sample C, i.e., the commercial product.

Test (D)

The aqueous PU adhesives crosslinked with Sample 9B or C were subjected to the adhesion test according to the above procedures. The test results are shown in Table 8.

TABLE 8

| | |
|---|---|
| Sample 9B | Sample C |

| | |
|---|---|
| Test Time | Peel Strength (kg/2.5 cm) |

| | | | |
|---|---|---|---|
| 10 | minutes | 25.5 | 19.3 |
| 1 | hour | 22.5 | 20.4 |
| 24 | hours | 25 | 23.5 |

According to the test results, the performance of Sample 9B in improving the adhesion of the aqueous PU adhesives exceeded that of Sample C, i.e., the commercial product.

Test (E)

The aqueous PU adhesives crosslinked with Sample 12B or C were subjected to the adhesion test according to the above procedures. The test results are shown in Table 9.

TABLE 9

| | |
|---|---|
| Sample 12B | Sample C |

| | |
|---|---|
| Test Time | Peel Strength (kg/2.5 cm) |

| | | | |
|---|---|---|---|
| 10 | minutes | 17 | 17.1 |
| 1 | hour | 24.6 | 23 |
| 24 | hours | 28 | 23 |

According to the test results, the performance of Sample 12B in improving the adhesion of the aqueous PU adhesives exceeded that of Sample C, i.e., the commercial product.

Test (F)

The aqueous PU adhesives crosslinked with Sample 13B or C were subjected to the adhesion and heat resistance after adhesion tests according to the above procedures. The test results are shown in Table 10.

TABLE 10

| | Sample 13B | Sample C |
|---|---|---|
| | Peel Strength (kg/2.5 cm) | |
| Test Time | | |
| 10 minutes | 9.4 | 8.3 |
| 1 hour | 16.5 | 11.5 |
| 24 hours | 25 | 18 |
| Heat resistance | | |
| Falling time of the mass | No falling occurred | No falling occurred |
| (min) | | |
| Released distance | 0.4 | 3 |
| between the substances | | |
| (cm) | | |

According to the test results, the performances of Sample 13B in improving the adhesion and heat resistance after adhesion of the aqueous PU adhesives exceeded those of Sample C, i.e., the commercial product.

Test (G)

The aqueous PU adhesives crosslinked with Sample 14B or C were subjected to the adhesion and heat resistance after adhesion tests according to the above procedures. The test results are shown in Table 11.

TABLE 11

| | Sample 14B | Sample C |
|---|---|---|
| | Peel Strength (kg/2.5 cm) | |
| Test Time | | |
| 10 minutes | 12 | 8.3 |
| 1 hour | 22.4 | 11.5 |
| 24 hours | 31 | 18 |
| Heat resistance | | |
| Falling time of the mass | No falling occurred | No falling occurred |
| (min) | | |
| Released distance | 1 | 3 |
| between the substances | | |
| (cm) | | |

According to the test results, the performances of Sample 14B in improving the adhesion and heat resistance after adhesion of the aqueous PU adhesives exceeded those of Sample C, i.e., the commercial product.

Test (H)

The aqueous PU adhesives crosslinked with Sample 15B or C were subjected to the adhesion test according to the above procedures. The test results are shown in Table 12.

TABLE 12

| | |
|---|---|
| Sample 15B | Sample C |

| | |
|---|---|
| Test Time | Peel Strength (kg/2.5 cm) |

| | | | |
|---|---|---|---|
| 10 | minutes | 9.5 | 5.2 |
| 1 | hour | 12.7 | 7.5 |
| 24 | hours | 13 | 12.5 |

According to the test results, the performance of Sample 15B in improving the adhesion of the aqueous PU adhesives exceeded that of Sample C, i.e., the commercial product.

Test (I)

The aqueous PU adhesives crosslinked with Sample 16B or C were subjected to the adhesion and heat resistance after adhesion tests according to the above procedures. The test results are shown in Table 13.

TABLE 13

| | Sample 16B | Sample C |
|---|---|---|
| | Peel Strength (kg/2.5 cm) | |
| Test Time | | |
| 10 minutes | 15.4 | 15.4 |
| 1 hour | 23.8 | 19 |
| 24 hours | 29 | 21.5 |
| Heat resistance | | |
| Falling time of the mass | No falling occurred | No falling occurred |
| (min) | | |
| Released distance | 0.3 | 7.3 |
| between the substances | | |
| (cm) | | |

According to the test results, the performances of Sample 16B in improving the adhesion and heat resistance of the aqueous PU adhesives exceeded those of Sample C, i.e., the commercial product.

It is clearly known from the above data that the aqueous resin adhesives modified by the water dispersible polyisocyanate composition bearing biuret of the present invention indeed provide better adhesive ability and heat resistance, compared with those modified by the current commercial products. Particularly, the aqueous resin adhesives crosslinked with the water dispersible polyisocyanate composition, which is synthesized by using a polyether diamine and a polyether diol in a ratio of about 2:3, provides the most preferred adhesion efficacy, especially a significant increase in both the aging adhesion strength and heat resistance after adhesion.

### Example 5

The preparation of water dispersible 5 polyisocyanate compositions by using a polyether monoamine and the measurement of the influence of reaction time on the viscosity of the composition.

The preparation procedures were as those described in Example 1, except that Monoamine-2 was reacted with HDI trimer. The viscosities of the obtained water dispersible polyisocyanate compositions were measured at each reaction time listed in Table 14. The amounts of HDI trimer and Monoamine-2 for the production of water dispersible polyisocyanate compositions, and the viscosities of the obtained water dispersible polyisocyanate compositions are shown in Table 14.

TABLE 14

| | | | | | Reaction | |
|---|---|---|---|---|---|---|
| Sample | Starting | Ratios | Ratios in | Added | temp. and | Viscosity |
| number | materials | in wt % | equivalents | amount (g) | time | (cps/° C.) |
| 17A1 | HDI trimer | 97 | 165.56 | 291 | RT/1 hr | 4680/28.5 |
| | Monoamine-2 | 3 | 1 | 9 | | |
| 17A2 | HDI trimer | 97 | 165.56 | 291 | RT/2 hr | 6350/28.5 |
| | Monoamine-2 | 3 | 1 | 9 | | |
| 17A3 | HDI trimer | 97 | 165.56 | 291 | RT/3 hr | 6700/28.5 |
| | Monoamine-2 | 3 | 1 | 9 | | |
| 17B1 | HDI trimer | 97 | 165.56 | 291 | 110° C./1 hr | 2840/28.5 |
| | Monoamine-2 | 3 | 1 | 9 | | |
| 17B2 | HDI trimer | 97 | 165.56 | 291 | 110° C./2 hr | 3056/28.5 |
| | Monoamine-2 | 3 | 1 | 9 | | |
| 17B3 | HDI trimer | 97 | 165.56 | 291 | 110° C./3 hr | 3240/28.5 |
| | Monoamine-2 | 3 | 1 | 9 | | |
| 17B4 | HDI trimer | 97 | 165.56 | 291 | 110° C./4 hr | 3400/28.5 |
| | Monoamine-2 | 3 | 1 | 9 | | |
| 17B5 | HDI trimer | 97 | 165.56 | 291 | 110° C./5 hr | 3712/28.5 |
| | Monoamine-2 | 3 | 1 | 9 | | |

According to the test results, the viscosities of the products of Samples 17A1 to 17A3 are increased with the increase of the reaction time. Nonetheless, after being heated to 110° C. and heated for 1 hour, the viscosity of the product of Sample 17B1 is decreased to 2840 cps/28.5° C. The viscosities of the products of Samples 17B2 to 17B5 are also increased with the increase of the reaction time.

Although the present invention has been described in detail in the foregoing for the purpose of illustration, it is to be understood that such detail is solely for that purpose and that variations can be made therein by those skilled in this art without departing from the spirit and scope of the present invention except as it may be limited by the claims.

1. A water dispersible polyisocyanate composition bearing urea comprising
(a) an aliphatic polyisocyanate or a mixture of aliphatic polyisocyanates or a mixture of aliphatic polyisocyanates with other polyisocyanates; and
(b) a reaction product of component (a) with component (c) a polyether amine or a mixture of a polyether amine and a polyether alcohol.

2. The water dispersible polyisocyanate composition bearing urea according to claim 1, wherein the aliphatic polyisocyanate is selected from the group consisting of isocyanurate, biuret, uretdione, urethane, allophanate, carbodiimide, oxadiazinetrione derivatives, and mixtures thereof.

3. The water dispersible polyisocyanate composition bearing urea according to claim 2, wherein the aliphatic polyisocyanate is a cyclic polyisocyanate selected from the group consisting of isocyanurate derivative, biuret derivative, and a mixture thereof.

4. The water dispersible polyisocyanate composition bearing urea according to claim 3, wherein the aliphatic polyisocyanate is selected from the group consisting of 1,6-hexamethylene diisocyanate (HDI) trimer, isophorone diisocyanate (IPDI) trimer, HDI/IPDI trimer, and a mixture thereof.

5. The water dispersible polyisocyanate composition bearing urea according to claim 4, wherein the aliphatic polyisocyanate is HDI trimer.

6. The water dispersible polyisocyanate composition bearing urea according to claim 1, wherein the other polyisocyanate is an aromatic polyisocyanate selected form the group consisting of 4,4-diphenylmethane diisocyanate (MDI), polymeric MDI, toluene diisocyanate, xylene diisocyanate, and a mixture thereof.

7. The water dispersible polyisocyanate composition bearing urea according to claim 1, wherein the polyether amine is selected from the group consisting of a polyether monoamine, polyether diamine, polyether triamine, and a mixture thereof, and the polyether alcohol is selected from the group consisting of a polyether monol, polyether diol, polyether triol, and a mixture thereof.

8. The water dispersible polyisocyanate composition bearing urea according to claim 1, wherein the polyether amine is selected from the group consisting of a polyether monoamine and a polyether diamine, and the polyether alcohol is a polyether diol.

9. The water dispersible polyisocyanate composition bearing urea according to claim 7, wherein the polyether monoamine and polyether diamine have a molecular weight of about 500 to about 3000 g/mole, and the polyether diol has a molecular weight of about 300 to about 1600 g/mole.

10. The water dispersible polyisocyanate composition bearing urea according to claim 9, wherein the polyether monoamine and polyether diamine have a molecular weight of about 600 to about 2500 g/mole, and the polyether diol has a molecular weight of about 500 to about 1000 g/mole.

11. The water dispersible polyisocyanate composition bearing urea according to claim 10, wherein the polyether monoamine and polyether diamine have a molecular weight of about 800 to about 1200 g/mole, and the polyether diol has a molecular weight of about 600 to about 800 g/mole.

12. The water dispersible polyisocyanate composition bearing urea according to claim 1, wherein the weight ratio of ethylene oxide (EO) to propylene oxided (PO) of the polyether amine and polyether alcohol is greater than about 50:50.

13. The water dispersible polyisocyanate composition bearing urea according to claim 12, wherein the weight ratio of ethylene oxide (EO) to propylene oxided (PO) of the polyether amine and polyether alcohol is between about 60:40 and about 95:5.

14. The water dispersible polyisocyanate composition bearing urea according to claim 13, wherein the weight ratio of ethylene oxide (EO) to propylene oxided (PO) of the polyether amine and polyether alcohol is between about 70:30 and about 90:10.

15. The water dispersible polyisocyanate composition bearing urea according to claim 7, wherein the polyether monoamine is selected from the group consisting of JEFFAMINE® M-1000 and JEFFAMINE® M-2070.

16. The water dispersible polyisocyanate composition bearing urea according to claim 7, wherein the polyether diamine is selected from the group consisting of JEFFAMINE® ED-600, JEFFAMINE® ED-900, JEFFAMINE® ED-2001, and JEFFAMINE® ED-2003.

17. The water dispersible polyisocyanate composition bearing urea according to claim 1, wherein the composition is prepared by reacting, based on the weight of the composition, about 99.5% to about 92% of component (a) with about 0.5% to about 8% of component (c).

18. The water dispersible polyisocyanate composition bearing urea according to claim 1, wherein the composition is prepared by reacting, based on the weight of the composition, about 98% to about 96% of component (a) with about 2% to about 4% of component (c).

19. The water dispersible polyisocyanate composition bearing urea according to claim 1, wherein the composition is prepared by reacting, based on the weight of the composition, about 99% to about 92% of component (a) with about 0.5% to about 4% of polyether amines and about 0.5% to about 4% of polyether alcohols.

20. The water dispersible polyisocyanate composition bearing urea according to claim 1, further comprising an inert organic solvent of low boiling point.

21. The water dispersible polyisocyanate composition bearing urea according to claim 20, wherein the solvent is selected from the group consisting of ethyl acetate, acetone, dimethyl ethyleneglycol, methylethylketone and a mixture thereof.

22. The water dispersible polyisocyanate composition bearing urea according to claim 1, wherein component (a) and component (c) are reacted at room temperature.

23. The water dispersible polyisocyanate composition bearing urea according to claim 22, wherein the reaction is conducted in the absence of a catalyst.

24. A water dispersible polyisocyanate composition bearing urea and urea derivatives comprising
(a) an aliphatic polyisocyanate or a mixture of aliphatic polyisocyanates or a mixture of aliphatic polyisocyanates with other polyisocyanates; and
(b) a reaction product of component (a) with component (c) a polyether amine or a mixture of a polyether amine and a polyether alcohol;
wherein the composition is prepared by heating for conducting a subsequent reaction so as to increase the numbers of isocyanate functional groups contained in said composition.

25. The water dispersible polyisocyanate composition bearing urea and urea derivatives according to claim 24, wherein the aliphatic polyisocyanate is selected from the group consisting of isocyanurate, biuret, uretdione, urethane, allophanate, carbodiimide, oxadiazinetrione derivatives, and mixtures thereof.

26. The water dispersible polyisocyanate composition bearing urea and urea derivatives according to claim 25, wherein the aliphatic polyisocyanate is a cyclic polyisocyanate selected from the group consisting of isocyanurate derivative, biuret derivative, and a mixture thereof.

27. The water dispersible polyisocyanate composition bearing urea and urea derivatives according to claim 26, wherein the aliphatic polyisocyanate is selected from the group consisting of 1,6-hexamethylene diisocyanate (HDI) trimer, isophorone diisocyanate (IPDI) trimer, HDI/IPDI trimer, and a mixture thereof.

28. The water dispersible polyisocyanate composition bearing urea and urea derivatives according to claim 27, wherein the aliphatic polyisocyanate is HDI trimer.

29. The water dispersible polyisocyanate composition bearing urea and urea derivatives according to claim 28, wherein the other polyisocyanate is an aromatic polyisocyanate selected form the group consisting of 4,4-diphenylmethane diisocyanate (MDI), polymeric MDI, toluene diisocyanate, xylene diisocyanate, and a mixture thereof.

30. The water dispersible polyisocyanate composition bearing urea and urea derivatives according to claim 24, wherein the polyether amine is selected from the group consisting of a polyether monoamine, polyether diamine, polyether triamine, and a mixture thereof, and the polyether alcohol is selected from the group consisting of a polyether monol, polyether diol, polyether triol, and a mixture thereof.

31. The water dispersible polyisocyanate composition bearing urea and urea derivatives according to claim 24, wherein the polyether amine is selected from the group consisting of a polyether monoamine and a polyether diamine, and the polyether alcohol is a polyether diol.

32. The water dispersible polyisocyanate composition bearing urea and urea derivatives according to claim 30, wherein the polyether monoamine and polyether diamine have a molecular weight of about 500 to about 3000 g/mole, and the polyether diol has a molecular weight of about 300 to about 1600 g/mole.

33. The water dispersible polyisocyanate composition bearing urea and urea derivatives according to claim 32, wherein the polyether monoamine and polyether diamine have a molecular weight of about 600 to about 2500 g/mole, and the polyether diol has a molecular weight of about 500 to about 1000 g/mole.

34. The water dispersible polyisocyanate composition bearing urea and urea derivatives according to claim 33, wherein the polyether monoamine and polyether diamine have a molecular weight of about 800 to about 1200 g/mole, and the polyether diol has a molecular weight of about 600 to about 800 g/mole.

35. The water dispersible polyisocyanate composition bearing urea and urea derivatives according to claim 24, wherein the weight ratio of ethylene oxide (EO) to propylene oxided (PO) of the polyether amine and polyether alcohol is greater than about 50:50.

36. The water dispersible polyisocyanate composition bearing urea and urea derivatives according to claim 35, wherein the weight ratio of ethylene oxide (EO) to propylene oxided (PO) of the polyether amine and polyether alcohol is between about 60:40 and about 95:5.

37. The water dispersible polyisocyanate composition bearing urea and urea derivatives according to claim 36, wherein the weight ratio of ethylene oxide (EO) to propylene oxided (PO) of the polyether amine and polyether alcohol is between about 70:30 and about 90:10.

38. The water dispersible polyisocyanate composition bearing urea and urea derivatives according to claim 30, wherein the polyether monoamine is selected from the group consisting of JEFFAMINEÒ M-1000 and JEFFAMINEÒ M-2070.

39. The water dispersible polyisocyanate composition bearing urea and urea derivatives according to claim 30, wherein the polyether diamine is selected from the group consisting of JEFFAMINE® ED-600, JEFFAMINE® ED-900, JEFFAMINE® ED-2001, and JEFFAMINE® ED-2003.

40. The water dispersible polyisocyanate composition bearing urea and urea derivatives according to claim 24, wherein the composition is prepared by reacting, based on the weight of the composition, about 99.5% to about 92% of component (a) with about 0.5% to about 8% of component (c).

41. The water dispersible polyisocyanate composition bearing urea and urea derivatives according to claim 24, wherein the composition is prepared by reacting, based on the weight of the composition, about 98% to about 96% of component (a) with about 2% to about 4% of component (c).

42. The water dispersible polyisocyanate composition bearing urea and urea derivatives according to claim 24, wherein the composition is prepared by reacting, based on the weight of the composition, about 99% to about 92% of component (a) with about 0.5% to about 4% of polyether amines and about 0.5% to about 4% of polyether alcohols.

43. The water dispersible polyisocyanate composition bearing urea and urea derivatives according to claim 24, further comprising an inert organic solvent of low boiling point.

44. The water dispersible polyisocyanate composition bearing urea and urea derivatives according to claim 43, wherein the solvent is selected from the group consisting of ethyl acetate, acetone, dimethyl ethyleneglycol, methylethylketone, and a mixture thereof.

45. The water dispersible polyisocyanate composition bearing urea and urea derivatives according to claim 24, wherein component (a) and component (c) are reacted at room temperature.

46. The water dispersible polyisocyanate composition bearing urea and urea derivatives according to claim 45, wherein the reaction is conducted in the absence of a catalyst.

47. The water dispersible polyisocyanate composition bearing urea and urea derivatives according to claim 24, wherein the composition is heated to a temperature of about 100 to about 150° C. and reacted at the temperature for about 2 to about 8 hours.

48. The water dispersible polyisocyanate composition bearing urea and urea derivatives according to claim 47, wherein the composition is heated to a temperature of about 110° C. and reacted at the temperature for about 5 hours.

49. The water dispersible polyisocyanate composition bearing urea and urea derivatives according to claim 24, wherein the urea derivatives comprise biuret, triuret, and tetrauret.

50. The water dispersible polyisocyanate composition bearing urea and urea derivatives according to claim 24, wherein the urea derivative are biuret.

51. A water dispersible polyisocyanate composition bearing biuret comprising
(a) an aliphatic polyisocyanate or a mixture of aliphatic polyisocyanates or a mixture of aliphatic polyisocyanates with other polyisocyanates; and
(b) a reaction product of component (a) with component (c) a polyether amine or a mixture of a polyether amine and a polyether alcohol;
wherein the composition is prepared by heating for conducting a subsequent reaction so as to increase the numbers of isocyanate functional groups contained in said composition.

52. An aqueous resin adhesive comprising an aqueous resin and the water dispersible polyisocyanate composition according to claim 1.

53. The aqueous resin adhesive according to claim 52, wherein the water dispersible polyisocyanate composition is in an amount of about 1 to about 5%, based on the weight of the aqueous resin.

54. The aqueous resin adhesive according to claim 53, wherein the water dispersible polyisocyanate composition is in an amount of about 2 to about 4%, based on the weight of the aqueous resin.

55. The aqueous resin adhesive according to claim 52, wherein the aqueous resin is selected from the group consisting of polyurethane, polyvinyl acetate, polyvinyl alcohol, hydroxy polyacrylate and a mixture thereof.

56. The aqueous resin adhesive according to claim 55, wherein the aqueous resin is aqueous polyurethane.

57. An aqueous resin adhesive comprising an aqueous resin and the water dispersible polyisocyanate composition according to claim 24.

58. The aqueous resin adhesive according to claim 57, wherein the water dispersible polyisocyanate composition is in an amount of about 1 to about 5%, based on the weight of the aqueous resin.

59. The aqueous resin adhesive according to claim 58, wherein the water dispersible polyisocyanate composition is in an amount of about 2 to about 4%, based on the weight of the aqueous resin.

60. The aqueous resin adhesive according to claim 57, wherein the aqueous resin is selected from the group consisting of polyurethane, polyvinyl acetate, polyvinyl alcohol, hydroxy polyacrylate and a mixture thereof.

61. The aqueous resin adhesive according to claim 60, wherein the aqueous resin is aqueous polyurethane.

62. An aqueous resin adhesive comprising an aqueous resin and the water dispersible polyisocyanate composition according to claim 51.

63. The aqueous resin adhesive according to claim 62, wherein the water dispersible polyisocyanate composition is in an amount of about 1 to about 5%, based on the weight of the aqueous resin.

64. The aqueous resin adhesive according to claim 63, wherein the water dispersible polyisocyanate composition is in an amount of about 2 to about 4%, based on the weight of the aqueous resin.

65. The aqueous resin adhesive according to claim 62, wherein the aqueous resin is selected from the group consisting of polyurethane, polyvinyl acetate, polyvinyl alcohol, hydroxy polyacrylate and a mixture thereof.

66. The aqueous resin adhesive according to claim 65, wherein the aqueous resin is aqueous polyurethane.
